(19) United States
(12) Patent Application Publication
(10) Pub. No.: US 2015/0039404 A1
(43) Pub. Date: Feb. 5, 2015

(54) WEIGHTED VOTING SYSTEM

(71) Applicant: Colin Segal, North Sydney NSW (AU)

(72) Inventor: Ric B. RICHARDSON, Ewingsdale NSW (AU)

(73) Assignee: COLIN SEGAL

(21) Appl. No.: 14/449,535

(22) Filed: Aug. 1, 2014

(30) Foreign Application Priority Data
Aug. 1, 2013 (AU) 2013902863

(51) Int. Cl. G07C 13/00; G06Q 30/02; G06Q 50/00

(52) U.S. Cl. CPC G07C 13/00; G06Q 50/01; G06Q 30/0282
USPC 705/12

(57) ABSTRACT

A method of weighting votes; said votes cast by users in respect of a user experience; said method comprising applying a mathematical weight to the vote of each user in respect of any given voting event; the weighting determined by application of at least a first weighting rule.

In preferred forms the method is applied in the context of an e-commerce system.

### TECHNICAL FIELD

The present invention relates to a voting system and, more particularly, a system which applies weights to the votes of participants. More particularly but not exclusively the system operates in conjunction with an e-commerce system, a social network or other web enabled platform. In this instance e-commerce system is to be interpreted broadly to include, for example, web enabled portals for buying and selling goods and services; social networks implemented via the World Wide Web; communication platforms including email, text, chat facilities, video communication facilities and the like.

### BACKGROUND

The problem of trying to stop manipulation and anomalies from occurring in voting and scoring systems is well known in the art. Intentional attempts to manipulate or skew a scoring or rating system are a constant problem especially where each vote is derived from an individual's personal taste or evaluation.

A prime example of this is online voting and rating where a web site may allow users to vote on or give scores to items being sold or reviewed. For example a person who owns a restaurant could have their friends submit favorable reviews to a restaurant guide web site and therefore positively skew the restaurants rating that may otherwise have had a lower score.

Also, users who have unreasonably negative or overly positive viewpoints could skew a reasonable score in such a system. This would make the resulting score unreliable and unusable in helping others make balanced decisions based on other users' feedback.

Further traditional voting and scoring systems give no preferential importance to users who actively give good quality reviews or votes in a timely manner when compared to others that only sporadically contribute their votes.

The described invention is designed to address these issues.

It is an object of the present invention to address or at least ameliorate some of the above disadvantages or provide a useful alternative.

### Notes

The term “comprising” (and grammatical variations thereof) is used in this specification in the inclusive sense of “having” or “including”, and not in the exclusive sense of “consisting only of”.

The above discussion of the prior art in the Background of the invention, is not an admission that any information discussed therein is citable prior art or part of the common general knowledge of persons skilled in the art in any country.

### SUMMARY OF INVENTION

Accordingly in one broad form of the invention there is provided a method of weighting votes; said votes cast by users in respect of a user experience; said method comprising applying a mathematical weight to the vote of each user in respect of any given voting event; the weighting determined by application of at least a first weighting rule.

Preferably the method further includes the application of a second weighting rule.

Preferably the method further includes the application of a third weighting rule.

Preferably each weighting rule applies a different criterion as against each other weighting rule.

Preferably the first weighting rule comprises voting characteristics of a voter when compared to all other voters' voting characteristics.

Preferably the second weighting rule comprises voting characteristics of a voter when compared to the voters own voting pattern in respect of previous voting events.

Preferably the third weighting rule comprises the timing of the voter votes as compared with the time all other voters vote in respect of the voting event.

Preferably the first weighting compares the voter's behaviour on this vote for this event against the voting behaviour for this event of other voters for this event.

Preferably the second weighting rule compares this voter's behaviour on this vote for this event against the voting behaviour of this voter for past events for which this voter voted.

Preferably the behaviour parameter is time of vote relative to time other voters voted for this voting event.

Preferably the weighting comprises a vote multiplier factor.

Preferably the multiplier factor is derived from a predetermined number of votes.

Preferably the predetermined number of votes is 100.

Preferably each weighting rule is applied as a subtraction of a number of votes from the predetermined number of votes.

In yet a further broad form of the invention there is provided a system for weighting votes; said votes cast by users in respect of a user experience; said system including a processor which receives data representative of votes from users of a specified platform; said processor applying an algorithm to said data in order to apply a mathematical weight to the vote of each user in respect of any given voting event elicited on that platform; the weighting determined by application of at least a first weighting rule thereby to minimize user bias.

Preferably the system further includes the application of a second weighting rule.

Preferably the system further includes the application of a third weighting rule.

Preferably each weighting rule applies a different criterion as against each other weighting rule.

Preferably the first weighting rule comprises voting characteristics of a voter when compared to all other voters' voting characteristics.

Preferably the second weighting rule comprises voting characteristics of a voter when compared to the voters own voting pattern in respect of previous voting events.

Preferably the third weighting rule comprises the timing of the voter votes as compared with the time all other voters vote in respect of the voting event.

Preferably the first weighting compares the voter's behaviour on this vote for this event against the voting behaviour for this event of other voters for this event.

Preferably the second weighting rule compares this voter's behaviour on this vote for this event against the voting behaviour of this voter for past events for which this voter voted.

Preferably the behaviour parameter is time of vote relative to time other voters voted for this voting event.

Preferably the weighting comprises a vote multiplier factor.

Preferably the multiplier factor is derived from a predetermined number of votes.

Preferably the predetermined number of votes is 100.

Preferably each weighting rule is applied as a subtraction of a number of votes from the predetermined number of votes.

In yet a further broad form of the invention there is provided a non-transitory computer readable media having code stored thereon which, when executed by a data processing system, implements the above described method.

In yet a further broad form of the invention there is provided a non-transitory computer readable media having code stored thereon which, when executed by a data processing system, implements the above described system.

Preferably the medium and data processing system receive vote data comprising data elements and wherein the data elements are communicated via a network protocol such as TCP/IP wherein data is transmitted in the form of packets.

Preferably each packet includes a header portion and an associated data payload portion.

Preferably each packet is routed to its addressed destination by means of address lookup tables stored in processing devices located elsewhere on the network.

### BRIEF DESCRIPTION OF DRAWINGS

Embodiments of the present invention will now be described with reference to the accompanying drawings wherein:

FIG. 1 illustrates main components of the example embodiment.

FIG. 2 illustrates an example of multi vote per person system.

FIG. 3 illustrates a weighting system when comparing user with all other item voters.

FIG. 4 illustrates a weighting system when compared with users own voting history.

FIG. 5 illustrates a weigh ting system when comparing user vote order.

FIG. 6 is a block diagram of a specific example of the weighted voting system of the present invention.

### DESCRIPTION OF EMBODIMENTS

### First Preferred Embodiment

The example embodiment discloses an example of the invention when applied to an item-selling web site where the site has users, items listed for sale and the ability for users to vote on those items based on their own opinion of the items being offered for sale.

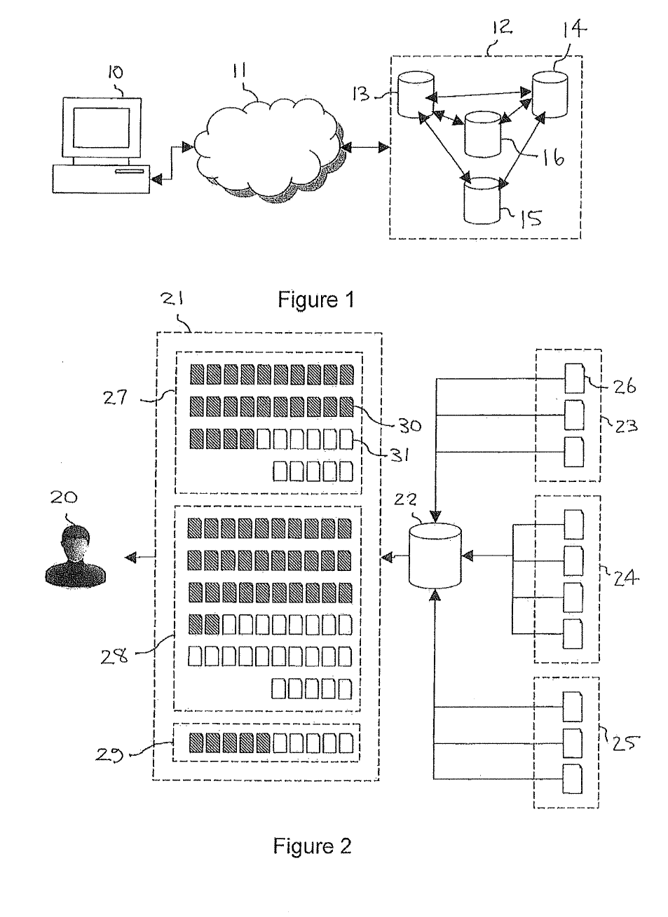

FIG. 1 discloses the main components of the example embodiment. A user 10 can connect to a site that uses voting 12 using the Internet 11. Users 10 can be encouraged to vote and give a score relating to items on a web site 12. The site may have a number of databases relating to the collation and management of user votes relating to items on the site. The example embodiment shows a user database 13 that is used to identify persons who vote on the web site. A vote database 15 is used to collect the votes made by people visiting the web site. An item database 14 contains information about items being presented or possibly sold on the web site. A weighting system 16 is used to ensure that intentional manipulation of votes is detected and avoided and also that users who are active in giving of their time to provide votes are rewarded with a higher weighting.

The weighting is a gauge set by the sites operators as to the integrity, reliability and general value of the votes made by a specific person. It also contains a mechanism that allows site operators to reward users who give of their time to provide feedback on items with a higher value over other users in the system.

FIG. 2 discloses how the voting system is different from a standard user rating system. In a standard voting or ranking system, each person who votes gets one vote and the score of the item they are voting for is determined by adding the scores together of all votes and dividing that score by the number of voters.

The example embodiment however gives each user 20 a larger number of votes 21 which are calculated based on the credibility of the voter and on their voting history. In this example the user is given a possible one hundred votes 21. Weighting system 22 uses three separate sets of rules 23 24 25 to calculate the users 20 weighting 21. Each rule 26 helps define how many votes 30 31 the user can use to give their opinion.

In this example the first set of rules 23 relates to the users voting pattern when related to others that have voted on the same item. If the users voting pattern shows them to be erratic, extreme or ma king attempts to skew the score for an item in a particular direction, then the weighting system 22 uses the rules 23 to give the user 20 less votes 30 with which to vote. In this example the rules 23 determine that the user can only vote with twenty four 27 of the possible thirty five votes, thereby significantly reducing the impact of their vote on the overall voting average for the item being voted upon.

The second set of rules 24 relates to the users voting pattern when compared to their own voting history. If the user shows by their voting pattern that they are unusually negative, or that they tend to vote the same way every time they vote, then the value of their vote becomes lower. The characteristics are defined by the rules in this set of rules 24. In this case the weighting system when using the rules 24 has reduced the number of votes the user can vote with from a possible fifty five to thirty two votes 28.

The third set of rules 25 relates to the position of the users vote relative to the time at which other users voted on the item being voted for. Users who vote very early are rewarded for giving of their time and effort by being given more voting power or votes than users who vote later on. In this example the weighting system has given the user five out of a possible ten votes 29 with which to give a score for the item.

In this exam pie embodiment the three categories of voting rules, a users voting pattern when compared to others 23, a users voting pattern when compared with their own voting history 24 and the timelines of their votes 25 are given different weights in terms of number of votes. In this example the most number of weighted votes is allocated to the persons voting pattern when compared with their own voting history 28. The next most important group of weighted votes is given to the category that compares the users voting history with others who vote on the same item 27. And finally the smallest number of weighted votes is allocated to the category related to how soon a user votes after an item is available for voting 29.

In calculating the overall score for an item being voted on by multiple users on a site, the score is traditionally defined by the total of all the scores given by users divided by the number of voters.

In this embodiment however, the score given to an item is calculated by multiplying a users combined total votes by their chosen score and then adding these totals up for all users who voted on the item. Then this total is divided by the total number of weighted votes of all voters of the item being voted on.

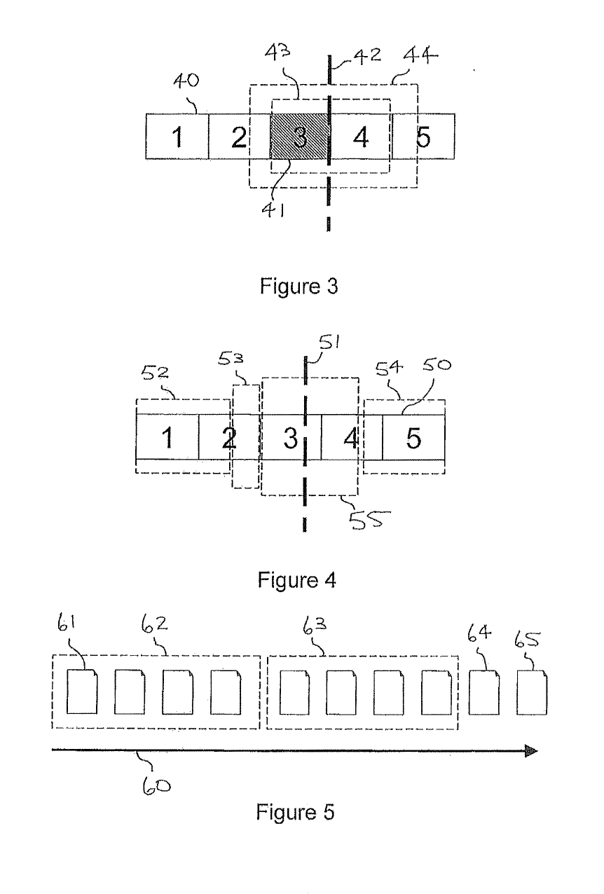

FIG. 3 shows examples of how rules that govern the number of votes given to a user can be weighted based on their voting characteristics when compared to other users who vote on the same item. In this case a five star voting system was used 40 where the user could chose a star rating of between one and five. In this case the user chose three stars 41. When averaged across all the votes for this item, the average score given by the users was three and a half stars 42. In this embodiment the rules give the maximum number of votes to a user who has voted within one star plus or minus of the average vote for the item 43. A medium number of votes is credited to a user who votes outside of one star plus or minus of the average vote but less than one and a half stars plus or minus of the average vote 44. All other users who give scores that are more than one and a half stars plus or minus of the average score are given the lowest number of weighted votes with which to vote. The overall affect this that users who tend to make extreme votes on items are given less voting power.

FIG. 4 shows examples of how rules that govern the number of votes given to a user can be weighted against their own voting history. In this example, the user's average voting score across all the items they have ever voted for on the site is just over three and a half stars 51. The rules of the weighting system give the lowest number of votes to a user who averages one to one and a half stars across all their votes 52. A user who votes less than three stars but more than one and a half on average is defined by the rules system as being overly negative and the user is given a low to medium number of weighted votes 53 with which to vote. On the other extreme a user who votes with five stars most of the time with an average of greater than four and a half stars 54 could be defined as being overly generous or simply repetitive in their voting and would receive a moderate to high number of weighted votes with which vote. The maximum number of weighted votes is given to users who vote between three and four and a half stars on average 55 because they show reasonable thoughtful scoring patterns without extremes.

FIG. 5 shows an example of how weighting rules can be applied to votes given to a user based on their timeliness and eagerness to give their opinion. In this case the operator of the web site wants to reward the user for voting sooner rather than later when an item becomes available for voting. After an item becomes available, users are able to record their votes over time 60. In this case the first four votes 62 are given the highest possible number of weighted votes. The next four votes 63 are given a medium number of weighted votes and the rest 64 65 of the votes receive the lowest number of weighted votes.

The result is a weighted voting system that excludes extreme or manipulative voting patterns and delivers a more realistic score of the item being voted on and also gives more recognition of the votes given by users who make an effort to vote early on an item rather than later.

### EXAMPLES

In summary, the disclosed weighting system is designed to stop a number of gaming situations where users try to manipulate ratings of items on a web site but preserve the genuine considered opinion of people who want to make a valid contribution or comment on the item.

The system also rewards users who are willing to jump in a give their opinion by making their vote worth more as rankings are calculated.

1. Preferred Main Test Criteria: One or More of
Voting characteristics when compared to all others (suggest 35% of rating)
Voting characteristics when compared to the users own voting pattern (suggest 55% of rating)
Quickness to vote after item becomes available for rating (suggest 10% of rating)
   A particular example with calculations of one version of the above described system now follows:
   Voting Characteristics when Compared to all Others

Measuring characteristics of a user's voting against the other users of the site means that there is an opportunity to tag extreme activities of people that have a hidden agenda in either “talking up” the rating of an item or “bagging” the item to give it an unusually low rating. In both cases it is desirable to exclude conceited or intentional efforts to skew a rating that would happen if the users just presented their honest opinion. This process assumes that the average user would represent a basis for common sense evaluation and rating of an item or product.

Methods to ascertain a weighting based on comparison with the average user:

1. Is the target user within:
a. 1 star either side of the average rating for all users for the item being voted on? Give them 3/3
b. 2 stars 2/3
c. more 1/20th
   2. Combine the total score for all items voted on by the user and divide by the total count of items voted on.

For example if 11 people voted a particular item and this user voted 3 stars where the average vote was 3.5 stars, the user would get 3 points out of a possible 3 for their weighting when combined with the test criteria where 35 points are allocated to the users voting habits when compared to others who voted on the same product, the weighting calculation would be 3/3*35=35.

Voting Characteristics when Compared to the Users Own Voting Pattern

This step involves trapping users in repetitive behavior where they are not contributing considered ratings but rather making knee jerk reactionary or contrived ratings.

This process assumes that an individual may vote based on taste and that the system should allow for such, but if the user has a pattern of making extreme ratings, that the value of their rankings be played down by the system.

For example if a user is always negative or always positive, the value of their rating to could be seen to be questionable. Also if there is no variance in their ratings (i.e. the ratings are always 1 or S or 3) then it could be assumed that the person is not thinking about their decision but rather taking a default action.

Methods to ascertain a weighting based on comparison with the users own activity:

If the average vote across all their votes is

a. <2 stars then give 1/4

b. <3 stars then 2/4

c. >4.5 stars 3/4

d. either >3<4.5 stars then 4/4

Quickness to Vote after Item Becomes Available for Rating

The importance of this factor is not related to the integrity of the rating given by the user but more a reward for those that are willing to vote earlier than other users. The advantage of this is that it will reward users for making an effort to look for and contribute to ratings of new items as they appear in an item database such as an Amazon product listing.

The principle here is to give a higher weighting to users who vote early to encourage voting leadership and support by the user for the website they are visiting.

Methods to reward users for early voting:
1. Sort all user votes by timestamp of vote and compare with average vote count on the site i.e. if vote count average is 9
   a. First four votes get 3/3
   b. Next 5 get 2/3
   c. The rest get 1/3

### Example Weighting Use:

If a user votes and gives an item 5 stars, their weighted vote would be calculated as follows:

Weighting when compared to others
The average vote for the item may be 3 but since this user has a history of voting within 1 star of the average for any typical item over their total of 10 votes, then the difference of 2 stars between the average and this user will not effect their overall position as a credible voter so this person will receive a score of 3 out of 3 for this vote.
If the weighting of the users vote when compared to others is set to represent 35% of the weighting value then this persons vote will receive 35 point of weighting measure.

Weighting when compared to others.
When comparing this vote with his other 10 votes it is clear that the user tends to just vote 5 every time which may mean that he is very pleased with everything he buys on the site, but it may also mean that he cannot be bothered to realty think about the rating so according to the weighting system described the user only gets a score of 3 out of 4.
If the weighting system gives a 55% value to the comparison of the users voting trends against their own voting history then the calculation is 55*3/4=41 points rounded.
Weighting of timeliness of vote.
The user is the 3rd of 6 people to vote so the user has a timeliness reward of 3 points out 3.
If the timeliness weigh ting factor is worth 10 point in the overall scheme then the user would get 3/3*10=10 points.
Over all the user would get a weighting of 91 points out of a possible 100 for their next vote.

The ranking for a weighted item would work as follows:
Even though an item may have 11 people vote for an item, with the weighted system, each vote is weighted . . . so instead of 1 vote per person, there is a potential of 100 votes per person. The persons weighting gives each person a weighted number of votes.
So a person with a high weighting of say 91 would have 91 votes for their ranking of say 4 stars.
If someone with a low weighting of say 29 decides to give the item a ranking of 2 then the ranking influence of this user in defining the average star rating or score for the item is radically changed.
By way of illustration:

| | | | |
|---|---|---|---|
| User 1 | 1 vote score for item 1 | Weighting 91 | 91 votes at 4 stars |
| User 2 | 1 vote score for item 2 | Weighting 19 | 19 votes at 2 stars |

Average item without weighting
Sum of scores/number of votes
6/2=3
So the average of the two voters without weighting is 3 stars
Average of item rating with weighting
Sum of (votes*score on a per user basis)/sum of votes per user
((91*4)+(19*2))/91+19 votes
382/110=3.47 stars
The difference is a whole half star more positive than a standard ranking because the voters had been weighted before the scoring took place.

### Alternative Embodiments

The example embodiment gives a possible one hundred voting rights to each user across three main categories of rules with a specific number and type of rules governing the allocation of weighted votes. An alternative embodiment could use any number of weighted votes for each user and could use any configuration or number of rules related to each category of weighting and any ratio of votes for each category that make up the total number of weighted votes. Further each category could be given any priority over another in order to calculate the overall weighted vote for a user.

The example embodiment uses a weighting system that gives votes to a user based on the timeliness of their votes as part of the weighting calculation. An alternative embodiment could use a weighting combination that only uses rules that relate to a users voting characteristics when compared to others and to the users own voting history but not their timeliness in voting.

The example embodiment is an application of the invention to an item selling web site. An alternative embodiment could be used in any digital or physical system where user voting is used. This could include but not be limited to market research systems, customer service feedback and opinion polls.

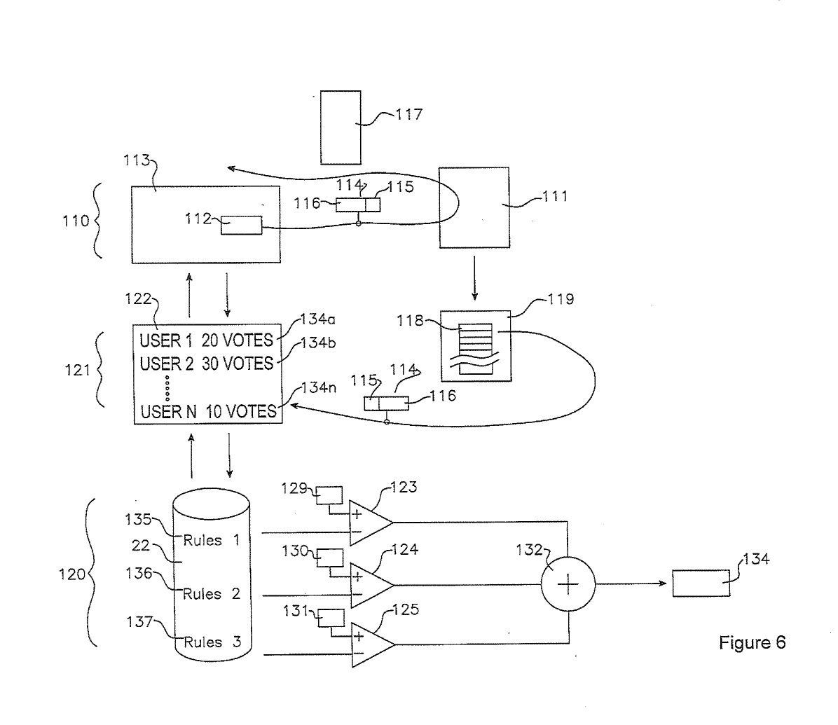

With reference to FIG. 6 a particular implementation of the system is illustrated in block diagram form.

In this instance there is an e-commerce system 110 which communicates with users over the Internet via an e-commerce system database 111 in order to display items 112 for purchase. The items may be goods or they may be services. Typically they are illustrated on the display screen 113 of a digital communications device which itself is in communication with the e-commerce system database 111. Typically communication is over the Internet utilising Internet protocol transmission wherein data is transmitted as packets 114. Each packet typically comprises a header portion 115 having an address and a payload portion 116 comprising data associated with the presentation and selection for purchase of the item 112. If a user completes a purchase of the item and 12 this is signaled to a warehouse 117 from which the item 112 is dispatched to the user.

Users which have appropriately experienced the e-commerce system 110 become qualified to vote on their experience with the system 110. The qualified users 118 are tabulated in a qualified users database 119 and are eligible to vote in relation to their experience. The qualified user database 119 retains Darfur in respect of all experiences and votes cast by the qualified users 118.

Any votes which the qualified users 118 decide to cast are processed through the weighted voting system 120 which is interfaced with the e-commerce system 110 by means of interface 121 which, in this instance, includes an output display 122 which displays results of votes cast by the qualified users.

In this instance the weighted voting system 120 comprises weighting system processor 22 (refer to FIG. 1) which, in this instance, drives hardware comparators 123, 124, 125.

The negative input of each comparator is subtracted from a predetermined vote number 139, 130, 131 respectively fed into the positive input of each comparator. The output of all of the comparators 123, 124, 135 is added by hardware adder 132 to provide a weighted vote output 134 for each user for each instance of voting by the user in respect of each item 112. The results are displayed on display 122 and are also stored in database 119 for use and reuse as required by the rules algorithms 135, 136, 137.

In preferred forms the predetermined vote number is an integer.

In a particular preferred form the comparators 123, 124, 125 subtract integer amounts from the respective predetermined vote number, the amounts subtracted varying according to the rule algorithms 135, 136, 137 as applied to each user casting a vote.

Particular examples given earlier in this specification nominate the total predetermined vote number as 100 across, in this instance, the three numbers 129, 130, 131. This is merely an example-other integer amounts can be utilised.

Whilst the example of FIG. 6 refers to a platform enabling trade in goods and/or services it would be understood that the methodology described above can be applied to many other web enabled platforms—effectively to any platform where a vote in some way relevant to that platform can be requested of users of that platform.

### INDUSTRIAL APPLICABILITY

Versions of the present system may be implemented primarily as databases operating in communication with e-commerce systems operating over the internet. Portions of the logic of the voting system can be implemented either in hardware or programmed into a data processing system.

1. A method of weighting votes; said votes cast by users in respect of a user experience; said method comprising applying a mathematical weight to the vote of each user in respect of any given voting event; the weighting determined by application of at least a first weighting rule.

2. The method of claim 1 further including the application of a second weighting rule.

3. The method of claim 1 further including a third weighting rule; each weighting rule applying a different criterion as against each other weighting rule.

4. The method of claim 1 wherein the first weighting rule comprises voting characteristics of a voter when compared to all other voters' voting characteristics.

5. The method of claim 1 wherein the second weighting rule comprises voting characteristics of a voter when compared to the voters own voting pattern in respect of previous voting events.

6. The method of claim 1 wherein the third weighting rule comprises the timing of the voter votes as compared with the time all other voters vote in respect of the voting event.

7. The method of claim 1 wherein the first weighting compares the voter's behaviour on this vote for this event against the voting behaviour for this event of other voters for this event.

8. The method of claim 1 wherein the second weighting rule compares this voter's behaviour on this vote for this event against the voting behaviour of this voter for past events for which this voter voted.

9. The method of claim 1 wherein the behaviour parameter is time of vote relative to time other voters voted for this voting event.

10. The method of claim 1 wherein the weighting comprises a vote multiplier factor.

11. The method of claim 1 wherein the multiplier factor is derived from a predetermined number of votes.

12. The method of claim 1 wherein the predetermined number of votes is 100.

13. The method of claim 1 wherein each weighting rule is applied as a subtraction of a number of votes from the predetermined number of votes.

14. A system for weighting votes; said votes cast by users in respect of a user experience; said system including a processor which receives data representative of votes from users of a specified platform; said processor applying an algorithm to said data in order to apply a mathematical weight to the vote of each user in respect of any given voting event elicited on that platform; the weighting determined by application of at least a first weighting rule thereby to minimize user bias.

15. The system of claim 14 further including the application of a second weighting rule.

16. The system of claim 15 further including a third weighting rule; each weighting rule applying a different criterion as against each other weighting rule.

17. A non-transitory computer readable media having code stored thereon which, when executed by a data processing system, implements the method of claim 1.

18. A non-transitory computer readable media having code stored thereon which, when executed by a data processing system, implements the system of claim 18.

19. The medium and data processing system of claim 18 wherein data elements are communicated via a network protocol such as TCP/IP wherein data is transmitted in the form of packets.

20. The medium and data processing system of claim 19 wherein each packet includes a header portion and an associated data payload portion.

21. The medium and data processing system of claim 20 wherein each packet is routed to its addressed destination by means of address lookup tables stored in processing devices located elsewhere on the network.
